(19) United States
(12) Patent Application Publication
(10) Pub. No.: US 2016/0281749 A1
(43) Pub. Date: Sep. 29, 2016

(54) FLUID PRESSURE CYLINDER AND METHOD OF MANUFACTURING THE CYLINDER

(71) Applicants: KYB-YS CO., LTD., Nagano (JP); KAYABA INDUSTRY CO., LTD., Tokyo (JP)

(72) Inventors: Nobuyuki KOBAYASHI, Nagano (JP); Sadayuki KAMIKURA, Nagano (JP); Yasuyuki NAGAI, Nagano (JP)

(73) Assignees: KAYABA INDUSTRY CO., LTD., Tokyo (JP); KYB-YS CO., LTD., Nagano (JP)

(21) Appl. No.: 14/777,943

(22) PCT Filed: Dec. 2, 2013
(86) PCT No.: PCT/JP2013/082362

§ 371 Date: Sep. 17, 2015

(30) Foreign Application Priority Data
Mar. 21, 2013 (JP) 2013-058509

(51) Int. Cl. F15B 15/14

(52) U.S. Cl. CPC F15B 15/14

(57) ABSTRACT

A fluid pressure cylinder extends and contracts in accordance with supply/discharge of fluid pressure to/from a cylinder tube is provided. On inner side of both end portions of the cylinder tube in an axial direction, at least one small-diameter portion having a diameter smaller than those of the end portions in the axial direction is formed by a spinning process.

### TECHNICAL FIELD

The present invention relates to a fluid pressure cylinder and a method of manufacturing the same.

### BACKGROUND ART

A fluid pressure cylinder that drives a driven unit of construction machineries etc. in a reciprocating manner has been known. JP2008-51194A describes a fluid pressure cylinder including a cylinder tube, a piston that can slide inside the cylinder tube in the axial direction, and a piston rod that is linked to the piston and that extends outside the cylinder tube.

Supply/discharge ports for fluid pressure are respectively provided on both end sides of the cylinder tube, and the pressures in fluid pressure chambers that are defined at both sides of the piston are adjusted. The piston slides in accordance with the pressure difference between the fluid pressure chambers, and the driven unit that is linked to the cylinder tube or the piston rod is driven.

### SUMMARY OF INVENTION

With the above-described conventional technology, the cylinder tube is formed from a raw tube material having a uniform outer diameter. Because the supply/discharge ports for the fluid pressure are formed on the outer circumference of the cylinder tube, the wall thickness of the raw tube material is set so as to be suitable for portions where the supply/discharge ports are formed and a high strength is required.

Thus, because the cylinder tube has the strength more than required at the portions where the supply/discharge ports are not provided, the weight of the cylinder tube is increased by a corresponding amount.

The object of the present invention is to provide a cylinder tube of a fluid pressure cylinder that is capable of reducing the weight while maintaining the strength of the cylinder tube.

According to one aspect of the present invention, a fluid pressure cylinder that extends and contracts in accordance with supply/discharge of fluid pressure to/from a cylinder tube is provided. On inner side of both end portions of the cylinder tube in an axial direction, at least one small-diameter portion having a diameter smaller than those of the end portions in the axial direction is formed by a spinning process.

### BRIEF DESCRIPTION OF DRAWINGS

FIG. 1 is a plan view showing a fluid pressure cylinder according to an embodiment of the present invention;

FIG. 2 is a diagram showing a step of fixing a raw tube material to a mandrel;

FIG. 3 is a diagram showing a step of performing a spinning process;

FIG. 4 is a diagram showing a cylinder tube after the spinning process;

FIG. 5 is a diagram showing a state in which a first supply/discharge port, a second supply/discharge port, and a holding member are attached to the cylinder tube.

### DESCRIPTION OF EMBODIMENTS

An embodiment of the present invention will be described below with reference to the attached drawings.

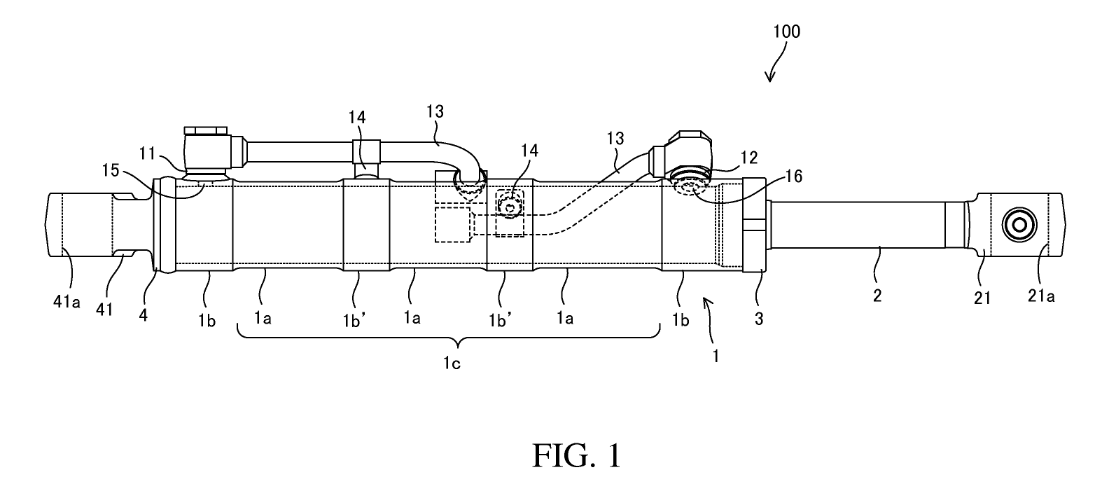

FIG. 1 is a plan view showing a fluid pressure cylinder 100 according to this embodiment. The fluid pressure cylinder 100 is used as an actuator for driving a driven unit of, for example, construction machineries etc.

The fluid pressure cylinder 100 uses oil as hydraulic fluid. It is not limited thereto, and working liquid or working gas, such as, for example, aqueous alternative liquid, may also be used instead of the oil.

The fluid pressure cylinder 100 includes a cylindrical cylinder tube 1, a piston (not shown) that can slide inside the cylinder tube 1 in the axial direction, a piston rod 2 in which one end thereof is linked to the piston and the other end thereof extends towards the outside of the cylinder tube 1, a cylinder head 3 that supports the piston rod 2 in a slidable and rotatable manner, and a bottom member 4 that seals the cylinder tube 1.

The piston partitions the inside of the cylinder tube 1 into a first fluid pressure chamber (not shown) at the one side (the left side in FIG. 1) in the axial direction and a second fluid pressure chamber (not shown) at the other side (the right side in FIG. 1) in the axial direction. The piston rod 2 has an eye portion 21 at the end portion of the cylinder tube 1 on the other side in the axial direction. The eye portion 21 has a circular through hole 21a that has the center axis extending in the direction perpendicular to the axis of the piston rod 2, and the through hole 21a is linked to a driven unit of a construction machinery etc.

The outer circumferential surface of the cylinder head 3 is screwed into an open end of the cylinder tube 1, that is, the inner circumferential surface of the open end on the side from which the piston rod 2 extends. Furthermore, the inner circumferential surface of the cylinder head 3 slidingly contacts with the outer circumferential surface of the piston rod 2.

The bottom member 4 is welded and fixed to the open end of the cylinder tube 1 on the opposite side of the cylinder head 3. The bottom member 4 has an eye portion 41 at the end portion of the cylinder tube 1 on the one side in the axial direction. The eye portion 41 has a circular through hole 41a that has the center axis extending in the direction perpendicular to the axis of the cylinder tube 1, and the through hole 41a is linked to the driven unit of the construction machinery etc.

The fluid pressure chamber within the cylinder tube 1 that is closed with the cylinder head 3 and the bottom member 4 is partitioned by the piston into the first fluid pressure chamber and the second fluid pressure chamber.

The cylinder tube 1 has a first through hole 15 that is formed so as to penetrate the wall of the cylinder tube 1 from the outer circumferential surface to the inner circumferential surface in the vicinity of the bottom member 4, and a second through hole 16 that is formed so as to penetrate the wall of the cylinder tube 1 from the outer circumferential surface to the inner circumferential surface in the vicinity of the cylinder head 3. The first through hole 15 is in communication with the first fluid pressure chamber, and the second through hole 16 is in communication with the second fluid pressure chamber.

Furthermore, the fluid pressure cylinder 100 includes a first supply/discharge port 11 that is welded and fixed to the outer circumferential surface of the cylinder tube 1 so as to be connected to the first through hole 15, a second supply/discharge port 12 that is welded and fixed to the outer circumferential surface of the cylinder tube 1 so as to be connected to the second through hole 16, a pipe 13 for supplying/discharging hydraulic fluid pressure to/from the first supply/discharge port 11 and the second supply/discharge port 12, and a holding member 14 that is welded and fixed to the outer circumferential surface of the cylinder tube 1 so as to hold the pipe 13 along the cylinder tube 1.

A flow rate and a flow direction of the hydraulic fluid pressure that is supplied from a pump (not shown) are controlled by a control valve (not shown), and the hydraulic fluid pressure is supplied/discharged through the pipe 13 to/from the first supply/discharge port 11 and the second supply/discharge port 12.

In other words, when the hydraulic fluid pressure is supplied to the first fluid pressure chamber through the first supply/discharge port 11, and the hydraulic fluid pressure in the second fluid pressure chamber is discharged through the second supply/discharge port 12, the pressure difference created between the first fluid pressure chamber and the second fluid pressure chamber causes the piston and the piston rod 2 to move towards the right direction in FIG. 1 and the fluid pressure cylinder 100 is operated so as to extend.

In addition, when the hydraulic fluid pressure is supplied to the second fluid pressure chamber through the second supply/discharge port 12, and the hydraulic fluid pressure in the first fluid pressure chamber is discharged through the first supply/discharge port 11, the pressure difference created between the first fluid pressure chamber and the second fluid pressure chamber causes the piston and the piston rod 2 to move towards the left direction in FIG. 1 and the fluid pressure cylinder 100 is operated so as to contract.

As described above, the driven unit of construction machineries etc. is driven by the extension or contraction of the fluid pressure cylinder 100.

Here, in a case in which the cylinder tube 1 is formed of a raw tube material having a uniform outer diameter, the wall thickness of the raw tube material is set such that the strength sufficient for the welding portions of the first supply/discharge port 11, the second supply/discharge port 12, and the holding member 14 where a high strength is required can be ensured.

However, there are other portions on the outer circumferential surface of the cylinder tube 1 where the welding portions are not provided, and the strength exceeding the required level for the cylinder tube 1 is ensured in such other portions, and therefore, the weight of the cylinder tube 1 is increased by a corresponding amount.

Thus, in this embodiment, for the portions of the outer circumferential surface of the cylinder tube 1 where a high strength is not required, the wall thickness is reduced to achieve weight reduction. The wall thickness is changed by performing a spinning process (also called as a flow forming process) at the corresponding portions.

Steps of manufacturing the cylinder tube 1 will be described below.

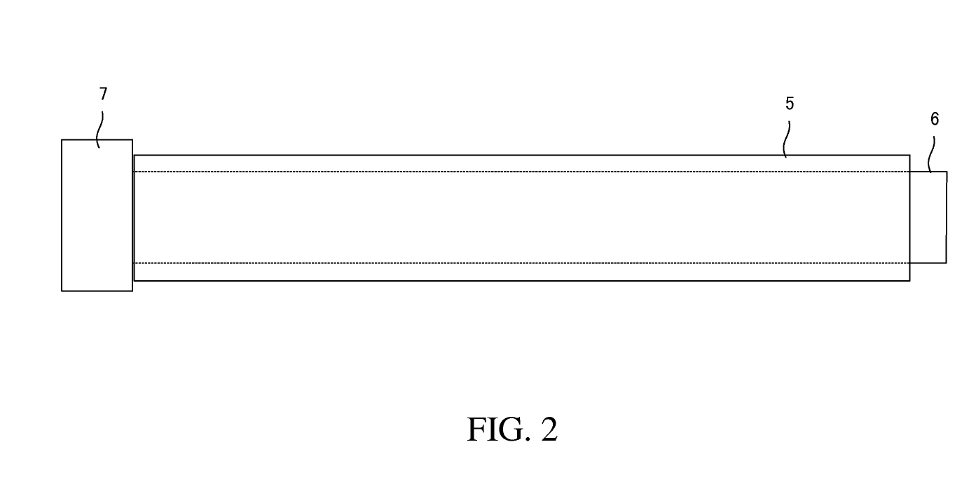

FIG. 2 is a diagram showing a step of fixing a raw tube material 5 to a mandrel 6.

The raw tube material 5 has a cylindrical shape having the uniform outer diameter and inner diameter, in other words, the uniform wall thickness. The mandrel 6 is linked to a rotationally-driven body 7 at one end thereof and has the outer diameter that is set so as to be substantially the same as the inner diameter of the raw tube material 5. The raw tube material 5 is fit into the mandrel 6 from the other end side of the mandrel 6 until it comes into contact with the rotationally-driven body 7.

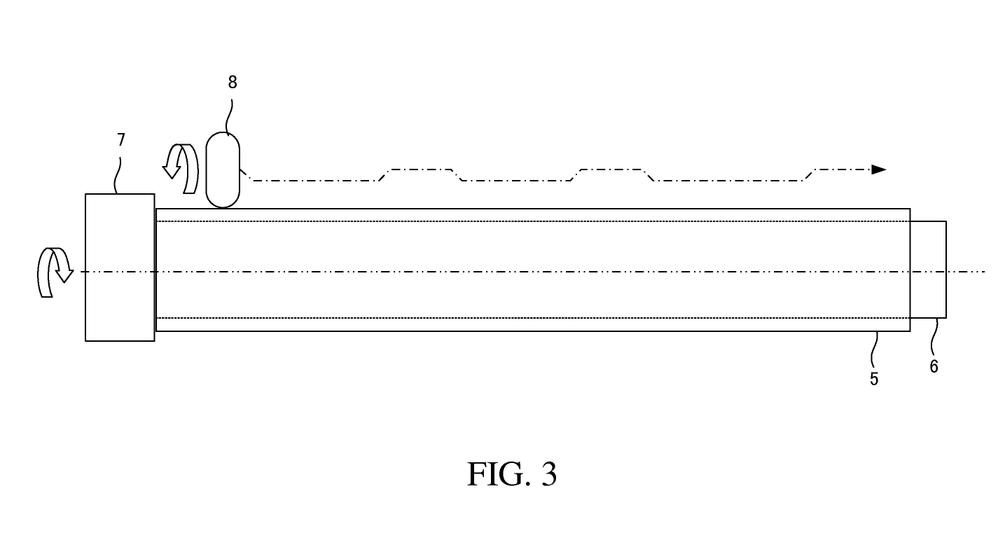

FIG. 3 is a diagram showing a step of performing the spinning process.

When the mandrel 6 is rotated about the center axis by the rotationally-driven body 7, the raw tube material 5 that is fit into the mandrel 6 is rotated together. Subsequently, a freely rotatable roller 8 is pressed against the outer circumferential surface of the rotating raw tube material 5. At this time, the roller 8 is rotated in the direction opposite to that of the raw tube material 5. By doing so, because the raw tube material 5 is squeezed between the mandrel 6 and the roller 8, the wall thickness of the raw tube material 5 is made thinner.

Furthermore, in a state in which the roller 8 is pressed against the outer circumferential surface of the raw tube material 5, the roller 8 is moved in the axial direction of the raw tube material 5. By doing so, the raw tube material 5 is compressed and stretched in the axial direction of the roller 8, and a region with the reduced wall thickness is formed in the raw tube material 5 so as to extend in the axial direction.

Thereafter, when the roller 8 is moved away from the outer circumferential surface of the raw tube material 5, the outer diameter of the raw tube material 5 remains the same even if the roller 8 is moved in the axial direction.

By performing the above mentioned operation repeatedly, the roller 8 leaves the trace illustrated by the one-dot chain line in FIG. 3.

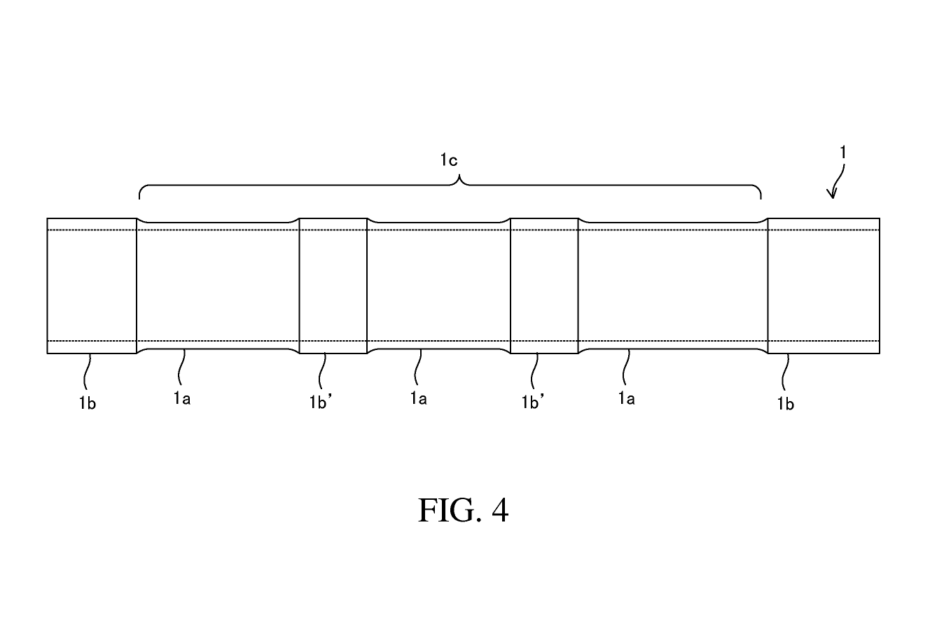

FIG. 4 is a diagram showing the cylinder tube 1 after the spinning process.

On the outer circumferential surface of the cylinder tube 1, small-diameter portions 1a that have the wall thickness reduced by the spinning process and large-diameter portions 1b, 1b′ that have not been subjected to the spinning process are formed in an alternated manner. The large-diameter portions 1b are formed at both end portions of the cylinder tube 1 in the axial direction, and two large-diameter portions 1b′ are formed in a middle region 1c at inner side of both end portions of the cylinder tube 1 in the axial direction. In addition, three small-diameter portions 1a that have the outer diameters reduced by the spinning process are formed in the middle region 1c.

With this configuration, a sufficient strength is ensured at the portions of the outer circumferential surface of the cylinder tube 1 where the first supply/discharge port 11, the second supply/discharge port 12, and the holding member 14 are to be attached by making these portions have large diameters. The portions without the first supply/discharge port 11, the second supply/discharge port, and the holding member 14 are made to have the reduced wall thickness by making the diameters smaller, thereby achieving weight reduction.

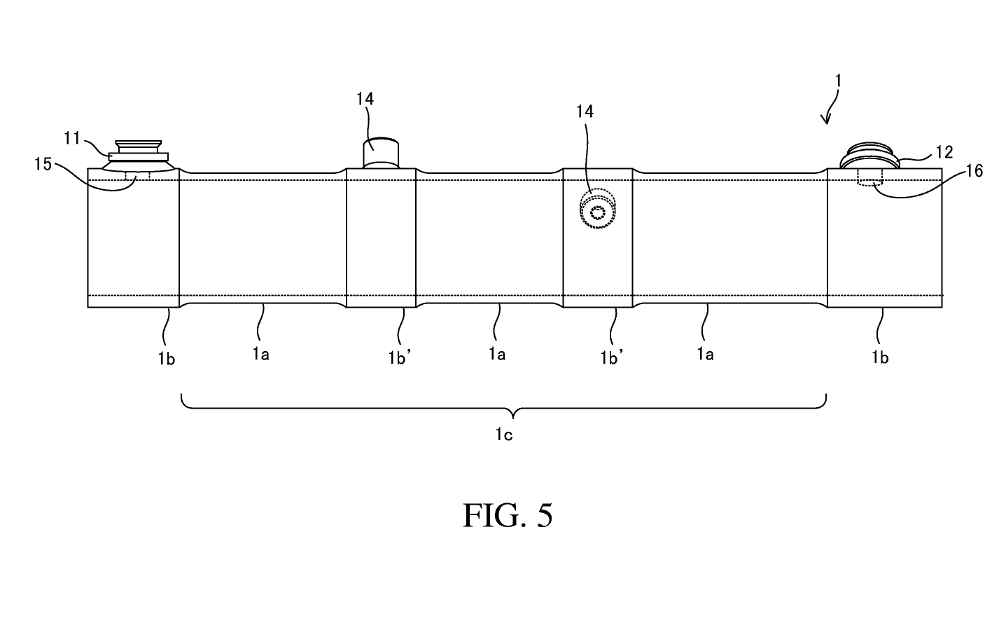

FIG. 5 is a diagram showing a state in which the first supply/discharge port 11, the second supply/discharge port 12, and the holding member 14 are attached to the cylinder tube 1.

At both end portions of the cylinder tube 1 in the axial direction, at which the large-diameter portions 1b are formed, the first through hole 15 and the second through hole 16 are formed, and the first supply/discharge port 11 and the second supply/discharge port 12 are welded and fixed thereto. In addition, the holding member 14 for holding the pipe 13 is welded and fixed to the two large-diameter portions 1b′ that are formed in the middle region 1c on the inner side of both end portions of the cylinder tube 1 in the axial direction.

By welding and fixing the bottom member 4 and by assembling the cylinder head 3 to the thus-manufactured cylinder tube 1, the fluid pressure cylinder 100 shown in FIG. 1 is manufactured.

According to the embodiment mentioned above, the advantages described below are afforded.

Because three small-diameter portions 1a whose outer diameters are reduced by the spinning process are formed in the middle region 1c on the inner side of both end portions of the cylinder tube 1 in the axial direction, it is possible to make the wall thickness of the cylinder tube 1 thin at the portions where a high strength is not required, and it is possible to achieve the weight reduction of the cylinder tube 1 while maintaining the strength thereof.

Furthermore, because the first supply/discharge port 11 and the second supply/discharge port 12 are welded and fixed to the large-diameter portions 1b that are formed on the outer circumferential surface of both end portions of the cylinder tube 1 in the axial direction, it is possible to ensure a sufficient strength for the cylinder tube 1.

Furthermore, because the holding members 14 are welded and fixed to the two large-diameter portions 1b′ that are provided between the small-diameter portions 1a in the middle region 1c, it is possible to ensure a sufficient strength for the cylinder tube 1.

Embodiments of this invention were described above, but the above embodiments are merely examples of applications of this invention, and the technical scope of this invention is not limited to the specific constitutions of the above embodiments.

For example, in the above-mentioned embodiment, although the roller 8 that is pressed against the raw tube material 5 is moved in the axial direction during the spinning process, the raw tube material 5 may be moved in the axial direction, or the roller 8 and the raw tube material 5 may be moved relative to each other in the axial direction.

Furthermore, in the above-mentioned embodiment, although three small-diameter portions 1a are formed in the middle region 1c, the number of the small-diameter portions 1a may be two, or four or more.

This application claims priority based on Japanese Patent Application No. 2013-058509 filed with the Japan Patent Office on Mar. 21, 2013, the entire contents of which are incorporated into this specification.

1. A fluid pressure cylinder that extends and contracts in accordance with supply/discharge of fluid pressure to/from a cylindrical cylinder tube, the fluid pressure cylinder comprising:
the cylinder tube;
a first closing member that closes one open end of the cylinder tube;
a second closing member that closes another open end of the cylinder tube;
a plurality of small-diameter portions having a diameter smaller than those of end portions in an axial direction, the plurality of the small diameter portions being formed in a middle region at inner side of both the end portions of the cylinder tube in the axial direction at prescribed intervals in the axial direction of the cylinder tube by a spinning process; and
a holding member provided on an outer circumferential surface between the plurality of the small-diameter portions formed in the middle region, the holding member being configured to hold a pipe that supplies/discharges the fluid pressure to/from the cylinder tube.

2. The fluid pressure cylinder according to claim 1, further comprising
supply/discharge ports welded and fixed to outer circumferential surfaces of both of the end portions in the axial direction, the supply/discharge ports being configured to supply/discharge the fluid pressure to/from the cylinder tube.

3. The fluid pressure cylinder according to claim 1, wherein outer diameters of the plurality of the small-diameter portions provided in the middle region are the same.

4. The fluid pressure cylinder according to claim 1, wherein outer diameters of both of the end portions in the axial direction are the same as an outer diameter of a portion in the middle region other than the small-diameter portions.

5. A method of manufacturing the fluid pressure cylinder according to claim 1, comprising:
fitting a mandrel inside the cylinder tube; and
performing a spinning process that reduces an outer diameter of the cylinder tube by rotating the cylinder tube, and while pressing a roller rotated thereby against an outer circumferential surface of the cylinder tube, moving the cylinder tube and the roller relative to each other in the axial direction of the cylinder tube; and
forming the plurality of the small-diameter portions in the middle region by the spinning process while performing the spinning process.
